(19) United States
(12) Patent Application Publication
(10) Pub. No.: US 2009/0219262 A1
(43) Pub. Date: Sep. 3, 2009

(54) Active Input Device for a Scanned Beam Display

(75) Inventors: Mark Champion, Kenmore, WA (US); P. Selvan Viswanathan, Redmond, WA (US); Randall B. Sprague, Hansville, WA (US)

Correspondence Address: MICROVISION, INC., 6222 185TH AVENUE NE, REDMOND, WA, 98052, US

(73) Assignee: MICROVISION, INC., Redmond, WA (US)

(21) Appl. No.: 12/466,318

(22) Filed: May 14, 2009

Related U.S. Application Data
(63) Continuation-in-part of application No. 11/967,156, filed on Dec. 29, 2007.

(51) Int. Cl. G06F 3/033; H04N 9/31

(52) U.S. Cl. 345/179; 348/744; 348/E09.025

(57) ABSTRACT

An input device (300) is provided for use with an image projection system (100). The input device (300) includes a first end (309) having a photodetector (302) and a second end (310) having a phototransmitter (303). An image projection system output beam (124) of photons is projected on a projection surface (140) along with a projected image (128). When the photodetector (302) receives the image projection system output beam (124), the phototransmitter (303) delivers a transmitted beam (324) back to the image projection system (100). The input device (300) can be equipped with user control mechanisms so as to act as a mouse or otherwise control the image projection system (100).

### CROSS REFERENCE TO PRIOR APPLICATIONS

This application is a continuation-in-part of commonly assigned, U.S. application Ser. No. 11/967,156, filed Dec. 29, 2007, entitled, “Input Device for a Scanned Beam Display,” which is incorporated by reference for all purposes.

### BACKGROUND

1. Technical Field

This invention relates generally to a control device for an image projection system, and more particularly to an active control device, such as a stylus pen, configured to receive information from a projection system and deliver information back to the image projection system upon receipt of information.

2. Background Art

Projection systems, such as those capable of projecting images onto screens, walls, and the like, are becoming smaller and more compact. By way of example, scanned beam displays employing lasers are becoming small enough to fit in portable electronic devices like palm sized computers, mobile telephones, personal digital assistants and gaming devices.

When using a projection system, it is sometimes desirable to provide feedback to the system. For instance, when an image is projected on a screen or wall, a user may want to actuate an icon or enter data based upon the image being projected. Traditionally, this is accomplished with a keyboard.

The use of a keyboard in a small electronic device is problematic in that many such devices have very small form factors. Consequently, the keyboards incorporated in such devices tend to be somewhat compromised—they are either very small or have a reduced number of keys. With small keyboards, the very small keys can be difficult to actuate properly. With a reduced number of keys, each key must be capable of entering multiple characters. As a result, a user may have to make several keystrokes to enter a single character.

Another prior art approach for providing input to a computer projection system is with a mouse. Prior art solutions for implementing a mouse typically require some form of horizontal, planar arranged hardware configured to detect the absolute X-Y position of the pointing device, such as a mouse. Such planar hardware can be difficult to achieve in a small, portable device.

Yet another prior art approach for providing input is via a touch-sensitive screen. Touch sensitive screens generally include capacitive sensing arrays, resistive sensing arrays, or wire grid arrays. Where an image is being projected on a passive surface, such as a wall, the passive surface will not include these arrays.

There is thus a need for an improved user input device suitable for use with image projection systems used to project images on passive surfaces.

### BRIEF DESCRIPTION OF THE DRAWINGS

FIG. 1 illustrates an image projection system suitable for use with an input device in accordance with embodiments of the invention.

FIG. 2 illustrates a light source suitable for use in the image projection system in accordance with embodiments of the invention.

FIG. 3 illustrates an input device in accordance with embodiments of the invention.

FIG. 4 illustrates an input device operating with an image projection system in accordance with embodiments of the invention.

FIG. 5 illustrates one embodiment of a light collector in accordance with embodiments of the invention.

FIG. 6 illustrates one embodiment of an input device in accordance with embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

Before describing in detail embodiments that are in accordance with the present invention, it should be observed that the embodiments reside primarily in combinations of method steps and apparatus components related to a user input device, such as a stylus, receiving a beam of photons from an image projection source and delivering a response beam or signal to the image projection system. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

It will be appreciated that embodiments of the invention described herein may be comprised of one or more conventional processors and unique stored program instructions that control the one or more processors to implement, in conjunction with certain non-processor circuits, some, most, or all of the functions of receiving the beam from the image projection source, amplifying the received signal, encoding data into a transmitted signal and sending the transmitted signal as described herein. The non-processor circuits may include, but are not limited to signal drivers, clock circuits, power source circuits, programmable processors, and user input devices. Alternatively, some or all functions could be implemented by a state machine that has no stored program instructions, or in one or more application specific integrated circuits, in which each function or some combinations of certain of the functions are implemented as custom logic. Of course, a combination of the two approaches could be used. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and circuits with minimal experimentation.

Embodiments of the invention are now described in detail. Referring to the drawings, like numbers indicate like parts throughout the views. As used in the description herein and throughout the claims, the following terms take the meanings explicitly associated herein, unless the context clearly dictates otherwise: the meaning of “a” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions. Also, reference designators shown herein in parenthesis indicate components shown in a figure other than the one in discussion. For example, talking about a device (10) while discussing figure A would refer to an element, 10, shown in figure other than figure A.

Embodiments of the present invention provide a user input device, such as a stylus that may be configured in one embodiment as an elongated cylinder or pointer, which can receive optic signals and information from a scanned image projection system and deliver a transmitted signal back to the image projection system. In one embodiment, the transmitted signal has a complementary transmission characteristic with the received signal. The user input device permits the transmission of information to the image projection system even though the user input device is not physically connected thereto. As such, the image projection system may receive control data even when projecting images on a passive surface, such as a wall. A user may manipulate the image along the passive surface, with manipulation information being sent back to the image projection system optically.

In one embodiment, the user input device is configured as a pen. At a first end is an image manipulation tip that includes a photodetector. At the other end of the pen is a phototransmitter. In one embodiment, the photodetector comprises an avalanche photodiode due to its advantageous sensitivity and signal to noise properties. Portions of light from the projection system, such as light used to form the image on the passive surface, are received by the photodetector.

In one embodiment, a high-speed trans-impedance amplifier is coupled between the photodetector and phototransmitter. The photodetector converts the light received from the image projection system to an electrical signal. The amplifier then provides gain to amplify the electrical signal.

When the portions of scanned light from the image projection system are received, the phototransmitter directs optic signals back to the image projection system. For example, in one embodiment the phototransmitter comprises an infrared light emitting diode. When the photodetector receives light from the projector, the infrared light emitting diode can be configured to pulse a return signal for transmission to the image projection source. In this basic embodiment, the stylus acts as a repeater to transmit an amplified return signal, which is complementary with the received signal, to the image projection system. In essence, the stylus is an active “repeater.”

In another embodiment, the user input device includes one or more user control mechanisms. For example, the user control mechanisms can include buttons, scroll wheels, slider devices, pressure or motion transducers, and the like. A control circuit is coupled to the user control mechanism and is configured to encode data relating to user manipulation of the user control mechanisms in the signal transmitted by the phototransmitter. In such an embodiment, the user input device can be used as a mouse or control mechanism. For instance, when a user actuates a button on the input device, the control circuit can append a code corresponding to the actuated button into the transmitted signal. The image projection system can then be configured to decode the transmitted signal so as to detect the actuated button and to respond accordingly. The user may employ this embodiment to manipulate the images, such as rotating, panning, or enlarging/reducing the image.

Note that in one embodiment, the photodetector need not be receiving the light or other signals from the image projection system for the user input device to be used as a image projection system control device. For example, the user may actuate a button or other user control on the user input device while the photodetector is not receiving information from the image projection system. The phototransmitter may then send a transmitted signal that is responsive to the user control actuation, rather than stimulation of the photodetector, to control the image projection system.

In another embodiment, the input device includes an orientation detector. In this embodiment, the user may employ the input device to manipulate images by changing the orientation of the device. For example, one type of orientation detector suitable for use with embodiments of the invention is an accelerometer. When the user changes an alignment of the input device relative to the image, this change is detected by the accelerometer. The control circuit can then encode data relating to this change into the transmitted signal.

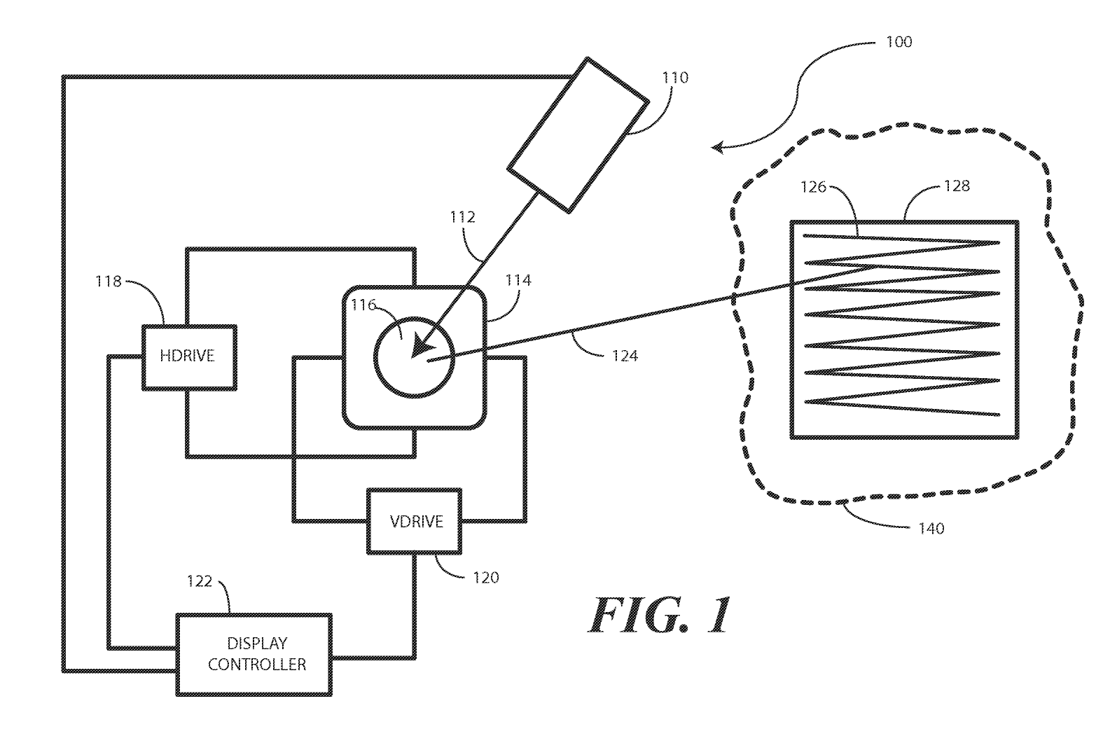

Turning now to FIG. 1, illustrated therein is a diagram of an image projection system 100 suitable for use with embodiments of the invention. In the illustrative embodiment of FIG. 1, for efficiency of discussion, the image projection system 100 is a scanned beam display, such as a Microelectromechanical System (MEMS) scanned laser source. MEMS scanned laser sources employ a MEMS scanning mirror to manipulate laser light to form an image. Examples of MEMS scanning mirrors, such as those suitable for use with embodiments of the present invention, are set forth in commonly assigned, copending U.S. patent application Ser. No. 11/786,423, filed Apr. 10, 2007, entitled, “Integrated Photonics Module and Devices Using Integrated Photonics Module,” which is incorporated herein by reference, and in U.S. Pub. patent application Ser. No. 10/984,327, filed Nov. 9, 2004, entitled “MEMS Device Having Simplified Drive,” which is incorporated herein by reference.

As shown in FIG. 1, image projection system 100 comprises a light source 110, which may be a laser light source or other light source. The light source 110 is configured to emit a beam 112 so as to project an image 128 on a projection surface 140. In one embodiment, the projection surface 140 is “passive” in that it is not electrically connected to the image projection system 100 so as to communicate and deliver information to the image projection system 100. Examples of such projection surfaces 140 include walls, screens, paper or cloth projection surfaces, and the like. Where the image projection system 100 is a MEMS scanned laser source, the light source 110 may comprise one or more lasers. In such an embodiment, the beam 112 will be a scanned laser beam.

The light source 110 can take a number of forms. For example, the light source 110 can be lasers or light emitting diodes. In many applications, lasers will be used due to their coherent beam. For example, the light source 110 can be a simple, monocolor laser. Alternatively, the light source 110 can comprise multiple lasers or a multicolor laser. For example, the light source 110 can include a red laser, a blue laser, and a green laser. Further, these lasers can be any of various types. For example, for compact designs, semiconductor-based lasers can be used, including edge emitting lasers or vertical cavity surface emitting lasers. In other applications, larger, more powerful lasers can be used, alone or in combination.

Where multiple lasers are used as the light source 110, one or more optical alignment devices (not shown in FIG. 1) may be used to orient the plurality of light beams into a single combined light beam. The alignment devices can further blend the output of each laser to form a coherent, multicolored beam of light. In one embodiment, dichroic mirrors can be used to orient the light beams into the combined light beam. Dichroic mirrors are partially reflective mirrors that include dichroic filters that selectively pass light in a narrow bandwidth while reflecting others.

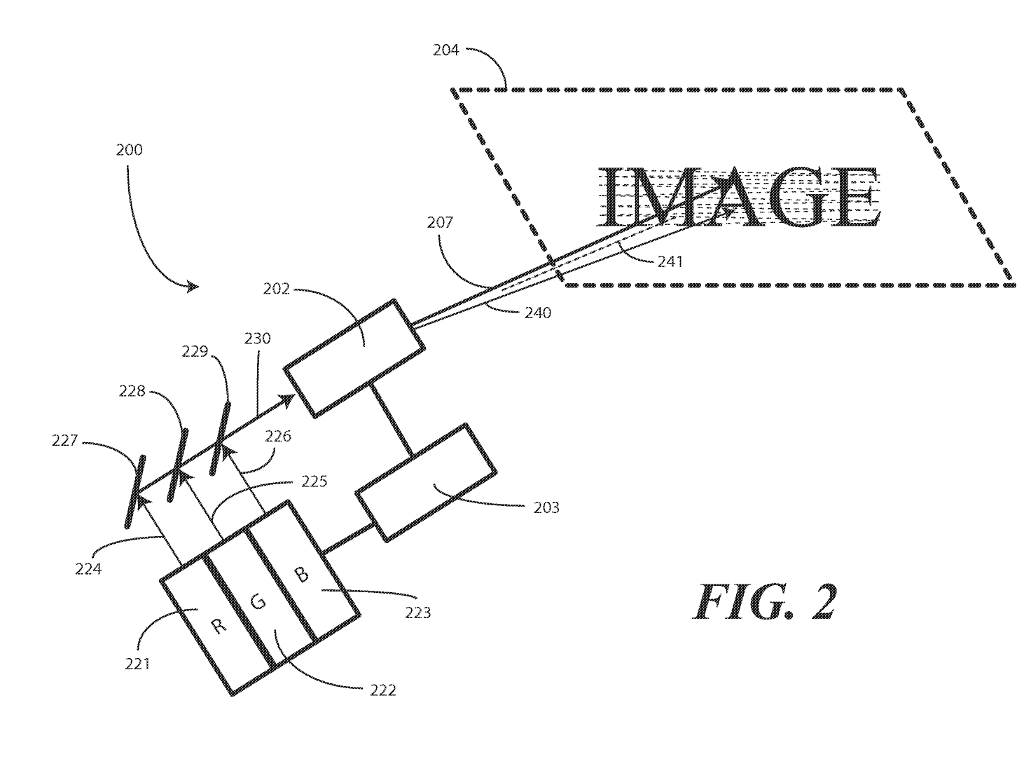

Turning briefly to FIG. 2, illustrated therein is a multi-laser system 200 suitable for use as the light source (110) of FIG. 1 and in accordance with embodiments of the invention. In the illustrative embodiment of FIG. 2, the laser projection source comprises a plurality of lasers 221,222,223. The plurality of lasers 221,222,223 produces a plurality of light beams 224,225,226. In one embodiment, the plurality of lasers 221,222,223 includes a red laser 221, a blue laser 222, and a green laser 223.

In the illustrative embodiment of FIG. 2, optical alignment devices 227,228,229 are then used to orient the plurality of light beams 224,225,226 into a combined light beam 230. Such a configuration permits a single, simple scanner 202 to be used. Note that multiple scanners can be used to deliver scanned light 207 to the projection surface 140 as well. Further, sophisticated scanners can be used to direct the plurality of light beams 224,225,226 as scanned light 207 to the projection surface 140. The embodiment of FIG. 2 is meant to be illustrative only, and is not meant to be limiting, as it will be clear to those of ordinary skill in the art having the benefit of this disclosure that any number of configurations of laser projection sources and scanners can be used with the projection surfaces and optical relays of the present invention.

In the illustrative embodiment of FIG. 2, dichroic mirrors are used as the optical alignment devices 227,228,229. The scanner 202, responsive to the control circuit 203, then produces the projected images on the projection surface 140 by modulating the combined light beam 230 (or alternatively the multiple light beams, as the case may be) and delivering it as scanned light 207 to the projection surface 140.

In one embodiment, the scanned light 207 includes a component 240 that has a predetermined transmission characteristic associated therewith. In one embodiment, this component 240 can be used for communication with the input device described below. Examples of transmission characteristics include transmission frequency, modulation technique, transmission direction, and so forth. Where visible light is used for communication, the transmission characteristic may be that the light is within the visible spectrum or a portion thereof. Where infrared beams are used for communication, the transmission characteristic may be that the beams are within the infrared spectrum or a portion thereof.

By way of example, in one embodiment the component 240 of scanned light 207 to be used for communication with an input device has a frequency within a predetermined frequency range. Where, for instance, a red laser 221, a blue laser 222, and a green laser 223 are used in the light system 200, the red laser 221 may be designated as the laser with which the input device will communicate. As such, the component 240 of the scanned light 207 used for communication may have a transmission characteristic that is a wavelength of between 620 and 750 nanometers. In another embodiment, an infrared beam 241 may be embedded into the scanned light 207 for communication. As such, the predetermined characteristic of this infrared beam 241 may be having a wavelength of between 850 nanometers and 50 micrometers.

Turning now back to FIG. 1, the beam 112 from the light source 110 impinges the scanning platform 114 having the scanner 116 disposed thereon. In the illustrative embodiment of FIG. 1, the scanner 116 comprises a MEMS based scanner. The beam 112 reflects off the scanner 116 to generate an image projection system output beam 124. A horizontal drive circuit 118 and a vertical drive circuit 120 may be used to modulate the direction in which scanner 116 deflects. This modulation causes the image projection system output beam 124 to generate the projected image 128.

In one embodiment, the projected image 128 can be created by way of a raster scan 126 displayed, for example, on the projection surface 140. In such an embodiment, a display controller 122 can control the horizontal drive circuit 118 and the vertical drive circuit 120 by converting pixel information of the displayed image into laser modulation synchronous to the scanning platform 114 to write the image information as an projected image 128 based upon the position of the image projection system output beam 124 in the raster scan 126 and the corresponding intensity and/or color information at the corresponding pixel in the image. The display controller 122 may also control other various functions of image projection system 100. Alternatively, the projected image 128 can be created by projecting individual pixels by scanning in a non-raster configuration. For example, the projected image 128 may be formed by scanning only image elements and omitting non-image elements, rather than performing a raster scan across the entirety of the image.

In one embodiment, in accordance with common nomenclature, a “fast scan axis” can refer to the horizontal direction of raster scan 126. Similarly, a “slow scan axis” may refer to the vertical direction of raster scan 126. The scanner 116 sweeps the image projection system output beam 124 left and right at a higher frequency and also vertically at a relatively lower frequency. The result is the scanned trajectory of the image projection system output beam 124, resulting in the raster scan 126. Each pixel in the projected image 128 is illuminated by image projection system output beam 124 at the exact same instant in time within each frame. Because, in this embodiment, each and every pixel in the projected image is illuminated at the exact same time with respect to the start of the refresh frame, it is possible for the display controller 122 to determine the X-Y position of a given pixel simply by knowing its timing relative to the start of the refresh frame. This information can be used with the input device described below to determine where the input device is within the projected image 128.

There are other methods of determining an X-Y location of a given pixel as well. For example, in one embodiment, instead of correlating the timing of the pixel to the start of a refresh frame, for noise and precision reasons it may be more appropriate to correlate the pixel timing relative to the start of the horizontal sync to obtain the X position and to the start of the vertical sync to obtain the Y position. Such an arrangement may produce better precision and stability in the X dimension in some applications.

In many image projection systems, the display controller 122 has knowledge of the pixel that it is projecting at any point in time, without any reference to timing relating to the start of a refresh frame or the start of a horizontal or vertical sweep in a raster scan. Embodiments of the present invention are well suited for determining a location of the input device within an image being projected by such a system. As will be described below, in one embodiment of the invention the input device has a photodetector and a phototransmitter. When the photodetector receives a beam of light, which will be a beam associated with a particular pixel, knowledge of which the display controller 122 has, the photodetector will transmit a beam back to the image projection system. By simply accounting for a predetermined latency associated with the input device, the display controller 122 knows exactly to which pixel the input device is pointing without the need of employing vertical or horizontal sweeping signals. Such an embodiment offers advantages in that reduced processing in the image projection system is required to determine to which pixel the input device is pointing.

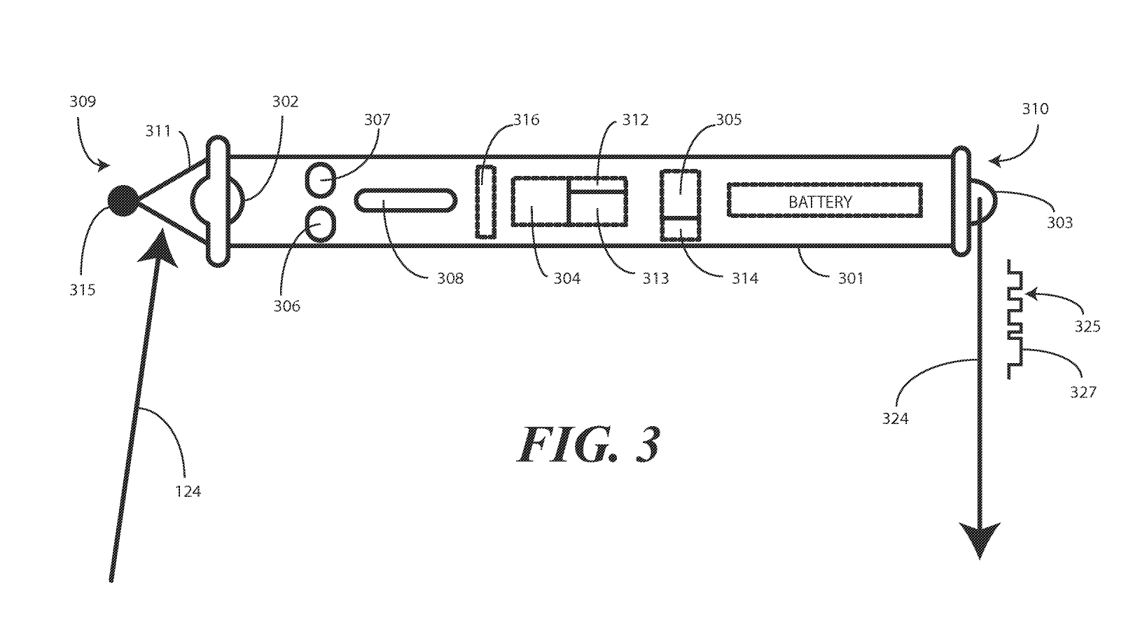

Turning now to FIG. 3, illustrated therein is one embodiment of an input device 300 suitable for use with embodiments of the invention. In one embodiment, the input device 300 is configured as a stylus, in that it is configured with an elongated body 301 that is cylindrical in cross section and includes a first end 309 and a distally disposed second end 310. In one embodiment, the first end 309 is tapered or otherwise configured as a scanned light detection end. In such a configuration, the input device 300 resembles a pen or pencil, which is convenient and ergonomic for use with projected images (128) projected on projection surfaces (140). While this stylus will be used herein as an illustrative embodiment, it will be clear to those of ordinary skill in the art having the benefit of this disclosure that the invention is not so limited. The input device 300 may be configured in any other number of ways, such as in a thimble type shape that slides onto one's finger, or as a semi-hemispherical device that can be easily passed along the projection surface (140).

The input device 300 includes a photodetector 302 and a phototransmitter 303. In the illustrative embodiment of FIG. 3, the photodetector 302 is disposed at the first end 309, while the phototransmitter 303 is disposed at the second end 310. The photodetector 302 is configured to receive a beam of photons from the image projection system (100). For example, the image projection system output beam 124 from FIG. 1 can serve as the beam of photons. The phototransmitter 303 is configured to deliver, in response to the photodetector receiving the image projection system output beam 124, a transmitted beam 324 of photons to the image projection system (100).

In one embodiment, the transmitted beam 324 will have the same transmission characteristic as the received beam, which in this case is image projection system output beam 124. For example, where image projection system output beam 124 includes a component (240) for communication that is an infrared beam, the phototransmitter 303 can be configured as an infrared light emitting diode such that the transmitted beam 324 has the same transmission characteristic as the received beam.

In another embodiment, the transmitted beam 324 will have a transmission characteristic that differs from the received beam. Using one illustrative embodiment from FIG. 2, if a red laser (221) is used for communication, and an infrared light emitting diode is used as the phototransmitter 303, the transmission characteristic of the received beam and the transmitted beam 324 will be different.

The photodetector 302 and phototransmitter 303 can take many different forms. For example, in one embodiment, the photodetector 302 is a simple photodiode configured to generate an electrical signal when incident light is received. In another embodiment, the photodetector 302 is an avalanche photodiode. Avalanche photodiodes are well known in the art and will not be discussed in detail here. An avalanche photodiode may be advantageous for use as the photodetector 302 in some embodiments due to their optical receiving sensitivity and signal to noise ratio dynamics. One example of an avalanche photodiode suitable for use with embodiments of the invention is the PDB-C 160SM manufactured by Advanced Photonics, Inc.

Just as various devices can be used as the photodetector 302, various devices can be used as the phototransmitter 303. As described above, in one embodiment the phototransmitter 303 is a light emitting diode. In one embodiment, the light emitting diode is an infrared light emitting diode. It will be clear to those of ordinary skill in the art having the benefit of this disclosure that the invention is not so limited however. Other devices, including non-infrared light emitting diodes, visible light emitting diodes, laser diodes, RF transmitters, and so forth can be used as the transmitter/phototransmitter 303. One example of a photodiode suitable for use with embodiments of the invention is the FSH 4254 infrared light emitting diode manufactured by Osram.

In one embodiment, the input device 300 includes a photoamplifier 304 electrically coupled between the photodetector 302 and the phototransmitter 303. In one embodiment, for example, the photoamplifier 304 comprises a high-speed transimpedance amplifier. This photoamplifier 304 provides gain to signals received by the photodetector 302 by magnifying the amplitude of the signal received by the photodetector 302.

In one embodiment, suitable for low-cost manufacture, a signal from the photoamplifier 304 is directed to a simple switch or comparator, where it is compared to a threshold. When the amplified signal exceeds the threshold, the phototransmitter 303 is actuated. The phototransmitter 303 can then be configured to transmit a pulsed or other signal to the image projection system (100). In such an operating mode, the input device 300 acts as a “repeater” by detecting a received beam and retransmitting a transmitted beam 324 back to the image projection source (101).

In some applications, this “active” user input device can offer advantages over other optical feedback devices, such as reflectors. For example, when an active input device is used, light only needs to travel in one direction before detection, whereas it must travel from the projector to the display surface and back again when using a reflector. Further, the transmitted beam 324 can have more intensity than a reflected beam in that it is being transmitted from an actively powered source. Next, the transmission characteristics of the transmitted beam 324 can be tailored to a particular application. Also, the transmitted beam 324 can be configured to be more omni-directional than a reflected beam, thereby relaxing any positional requirements associated with a reflector. Where a visible source is used as the phototransmitter 303, the transmitted beam 324 serves as visible feedback to the user that information is being delivered to the image projection system (100).

In another embodiment, rather than using a simple switch or comparator, a control circuit 305 can be used to provide the input device 300 with additional functionality and intelligence. Examples of control circuits include a microprocessor or other programmable device that executes embedded instructions stored in a memory 314. The control circuit 305 can be used to encode the transmitted beam 324 with information relating to the status or position of the input device 300 by way of an encoder 313.

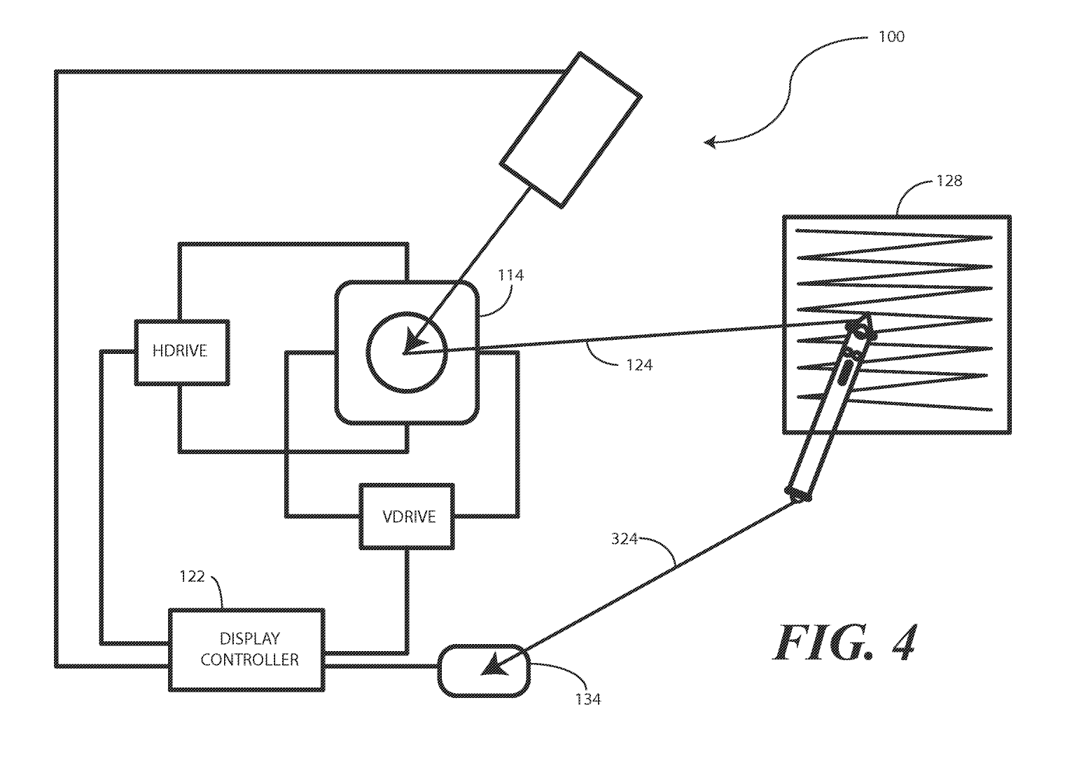

For example, in one embodiment, the input device 300 includes user control mechanisms disposed along the side of the input device 300. The user control mechanisms allow the input device to function as a mouse or pointer and to control some of the functions of the image projection system (100). In the illustrative embodiment of FIG. 4, the user control mechanisms include a right mouse button 307, a left mouse button 306, and a scroll wheel 308. It will be clear to those of ordinary skill in the art having the benefit of this disclosure that these buttons are illustrative only, and that the user control mechanisms may have other functions or may have functionality that is user programmable. When the user manipulates one or more of these user control mechanisms, the control circuit 305 is configured to encode user control data 325 in the transmitted beam 324. The image projection system (100) then receives this user control data 325, decodes the data, and responds according to the control instructions therein.

In one embodiment, the user can manipulate the user control mechanisms to control the image projection system (100) regardless of whether the photodetector 302 is receiving light from the image projection system (100). Where the photodetector 302 is not receiving information from the image projection system (100), the control circuit 305 can be configured to encode user control data 325 in the transmitted beam 324. The transmitted beam 324 in such a scenario may only be used for macro-control, such as alteration of an entire image, as the image projection system (100) does not have information relating to a location of the input device 300 within an image.

In one embodiment, the user control data 325 is encoded in the form of a short code burst immediately following a trigger bit 327 or leading beam received indicator of the transmitted beam 324. For example, the user control data 325 can be configured as a serial code. As an indication of when the image projection system output beam 124 was received is important in some applications, the leading edge or leading bit of the serial code serves as a beam received indicator and will often be the first portion of information of the code. Said differently, it will “lead” the other bits in the serial code. The remainder of the code may then comprise one or more bits representing the state of the left mouse button 307, one or more bits representing the state of the right mouse button 306, and one or more bits representing the state of the scroll wheel 308. The control circuit 305 can be configured to encode these bits on the transmitted signal when the user manipulates the user control mechanisms. Alternatively, when the image projection system output beam 124 is received by the photodetector 302, the code can be transmitted at that time.

The control circuit 305 can be used in other ways as well. In one embodiment, the input device 300 has a unique identifier associated therewith. This unique identifier could be a serial number, device number, or other indicator that uniquely identifies which input device is transmitting the transmitted beam 324. The unique identifier can be stored in the memory 314. When sending the transmitted beam 324, the control circuit 305 can encode the unique identifier into the transmitted beam 324 to alert the image projection system (100) just which input device 300 is sending the transmitted beam 324. Such a configuration allows a user or users to employ multiple input devices simultaneously.

The input device 300 can further include a pressure detector 315 disposed at the first end 309 of the input device 300. Examples of suitable pressure detectors include piezoelectric devices, force sensing resistors, and capacitively coupled force sensing devices. In one embodiment the pressure detector 315 is coupled to the control circuit 305 such that the control circuit can determine an amount of pressure being applied by the user against the projection surface (140). The pressure detector 315 may be coupled to an A/D converter 312, which is coupled to the control circuit 305. The control circuit 305 can then encode pressure data in the transmitted beam 324 by way of the encoder 313 upon receiving the image projection system output beam 124 and determining the amount of pressure being applied. Additional pressure detectors may be disposed along the sides of the input device 300 to determine the amount of pressure with which the user is grasping the input device 300.

In one embodiment, the input device 300 includes a beam collector 311 that is configured to direct the image projection system output beam 124 to the photodetector 302. The beam collector 311, in the illustrative embodiment of FIG. 3, is tapered so that the first end 309 of the input device 300 functions as an image manipulation end. Said differently, the beam collector 311 can be tapered or otherwise configured such that it is apparent to the user that the first end 309 is to be directed towards the image when the input device 300 is held in the hand. The beam collector 311 may include waveguides, optical relays, light pipes, or other features that assist in directing the image projection system output beam 124 to the photodetector 302. Where a pressure detector 315 is used, the pressure detector 315 may be integrated in, or coupled to, the beam collector 311.

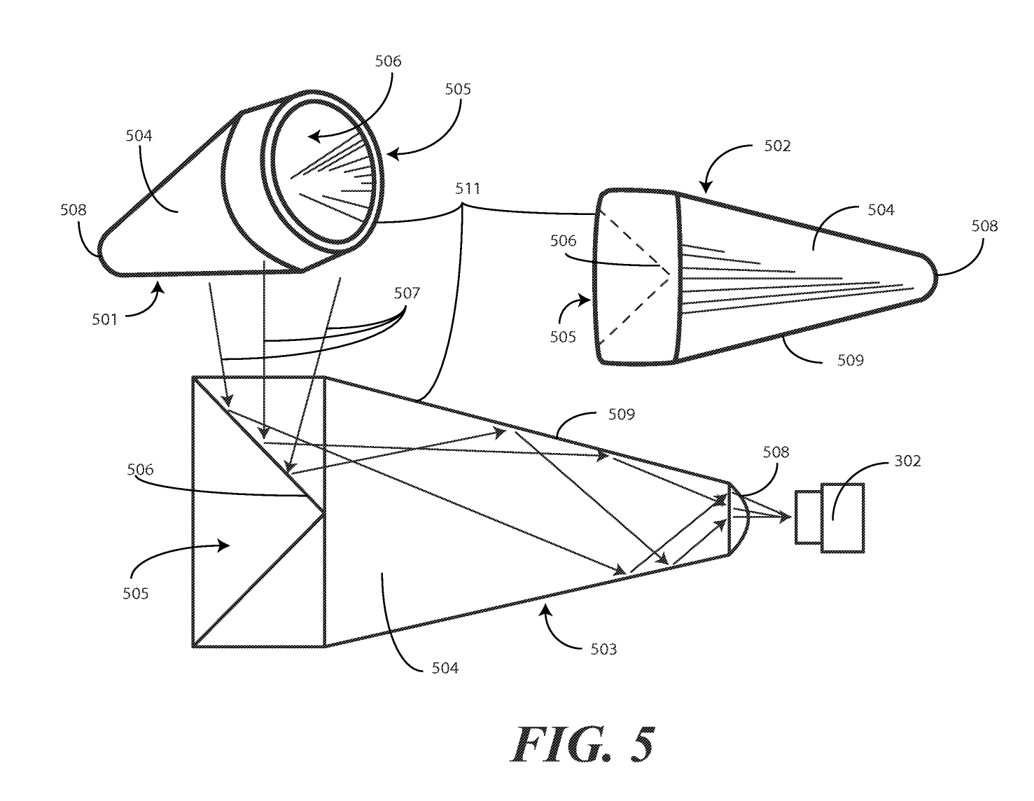

Turning now briefly to FIG. 5, illustrated therein is a more detailed view of one embodiment of one beam collector 511 suitable for use with embodiments of the invention. The beam collector 511 can be seen from three different angles—a front, left, bottom perspective view 501, a side elevation view 502 and a side elevation cross sectional view 503.

The beam collector 511 is tapered at a first end 504, and has a circular cross section at the second end 505. The beam collector 511 includes a conical recess 506 that both collects light 507 and directs it to the tip 508 so that it sill be received by the photodetector 302. Both the conical recess 506 and the sides 509 of the beam collector 511 serve as partially reflective or reflective surfaces to guide the light 507 to the photodetector 302.

Turning now back to FIG. 3, in addition to the user control mechanisms and pressure detector 315, other control mechanisms can be integrated with the input device 300. For example, orientation of the input device 300 relative to the image projection surface (140) can be used as a control mechanism. In one embodiment, the input device 300 includes at least one input device orientation detector 316 that is configured to determine a geometric orientation of the input device 300 relative to the projected image (128) or image projection surface (140). Examples of suitable input device orientation detectors 316 include gyroscopes and accelerometers. Alternatively, multiple photodetectors can be used as the photodetector 302 to deliver device orientation information to the control circuit 305. Each photodetector can compare the intensity of its received beam to determine which photodetector is closest to the projected image 128, thereby determining the input device's orientation. Once the physical orientation of the input device 300 is determined, the control circuit 305 can encode input device orientation data into the transmitted beam 324. This information can be transmitted when the orientation of the input device 300 changes, when the image projection system output beam 124 is received, or combinations thereof.

The circuitry of the input device 300 may insert some delay between receipt of the image projection system output beam 124 by the photodetector 302 and delivery of the transmitted beam 324 by the phototransmitter 303. In time sensitive applications, such as determining the exact location of the input device 300 within a projected image (128) as will be described below, the control circuit 305 can be configured to compensate for this delay. Specifically, in one embodiment, the control circuit 305 is configured to determine an input device latency associated with the circuit components of the input device 300. This input device latency may be constant in some input devices, or may vary depending upon what features are installed on a particular input device or upon what controls are being manipulated. In either case, the input device latency is defined by the delay occurring between the photodetector 302 receiving the image projection system output beam 124 and the phototransmitter 303 delivering the transmitted beam 324 to the image projection system (100). Where desired, the control circuit 305 can determine this latency and can encode the input device latency in the transmitted beam 324 by way of the encoder 313. This information can be sent to the image projection system (100) upon the photodetector 302 receiving the image projection system output beam 124 and the latency being either retrieved from memory or calculated.

Turning now to FIG. 4, illustrated therein is the input device 300 being used in conjunction with an image projection system 100 in accordance with one embodiment of the invention. In FIG. 4, the image projection system 100 includes elements described with respect to FIG. 1, and the input device 300 includes elements described with respect to FIG. 3. Those elements will not be repeated here. Instead, the interaction of the input device 300 with the image projection system 100 will be described through exemplary applications and use cases. It will be clear to those of ordinary skill in the art having the benefit of this disclosure that the invention is not so limited however. There are a vast number of image manipulation operations that are well known in the art that can be accomplished with the system.

In the illustrative embodiment of FIG. 4, the input device 300 is placed by a user on or near the displayed image 128 so that image projection system output beam 124 impinges on the photodetector (302) of the input device 300. The photodetector 302, upon receiving the image projection system output beam 124, generates an electrical pulse that is delivered to the control circuit (305). The electrical pulse is in response to the photo energy of image projection system output beam 124. The phototransmitter (303) then delivers the transmitted beam 324 to a detector 134 on the image projection system 100. The delivery of the transmitted beam 324 informs the image projection system that an input device 300 is present. Further, as described above, the transmitted beam 324 can inform the image projection system 100 of other information as well, including user control information, unique identifier information, orientation information, pressure information, and so forth.

In one illustrative application, the timing of the transmitted beam 324 may be correlated with a pixel being presented by the image projection system 100, or alternatively with the horizontal sync signal and/or vertical sync signal for driving scanning platform 114, in order to determine the location of the first end (309) of the input device 300. Where the image projection system 100 has an absolute knowledge of the pixel being presented, knowledge of the horizontal sync signal or vertical sync signal is not required, as the location may be correlated to a pixel or sub-portion of the displayed image 128 directly. In order to accurately correlate the timing of the transmitted beam 324 with either a pixel or the horizontal and/or vertical sync signals, the control circuit (305) may further deliver input device latency information in the transmitted beam 324.

The user may place the input device 300 on a portion of the displayed image 128. The portion may be a selected pixel of, or may be proximately located with one or more pixels, of displayed image 128. The image projection system 100 uses the transmitted beam 324 for determining the X-Y position of the input device 300 by correlating it with any of an image sync, horizontal sync, vertical sync, or absolute knowledge of the location of the pixel proximately located with the input device 300 in displayed image 128. The image projection system output beam 124 illuminates the first end (309) of the input device 300, which is detected by the photodetector (302). The timing of this illumination provides a pixel timing signal by way of transmitted beam 324. The display controller 122 then contains information relating to the pixel being presented, or alternatively to the timing information for the V-sync and H-sync signals. The display controller 122 thus uses the transmitted beam 324 as a detector signal to determine the position of the input device 300 within the projected image 128. The rising or falling edge of trigger bit (327) of the transmitted beam 324 may then be used as a timing pulse for the selected pixel.

In one or more embodiments, the input device 300 can be utilized in conjunction with image projection system 100 to implement the pointing function of a mouse. In one or more embodiments, other mouse functions may be implemented, for example conventional mouse buttons, wherein actuation of such buttons may be communicated back to the host device as described above. The display controller 122 of the image projection system 100 can compute the X-Y position of the first end (309) of the input device 300 and the control circuit (305) can communicate mouse button actuation through the transmitted beam 324.

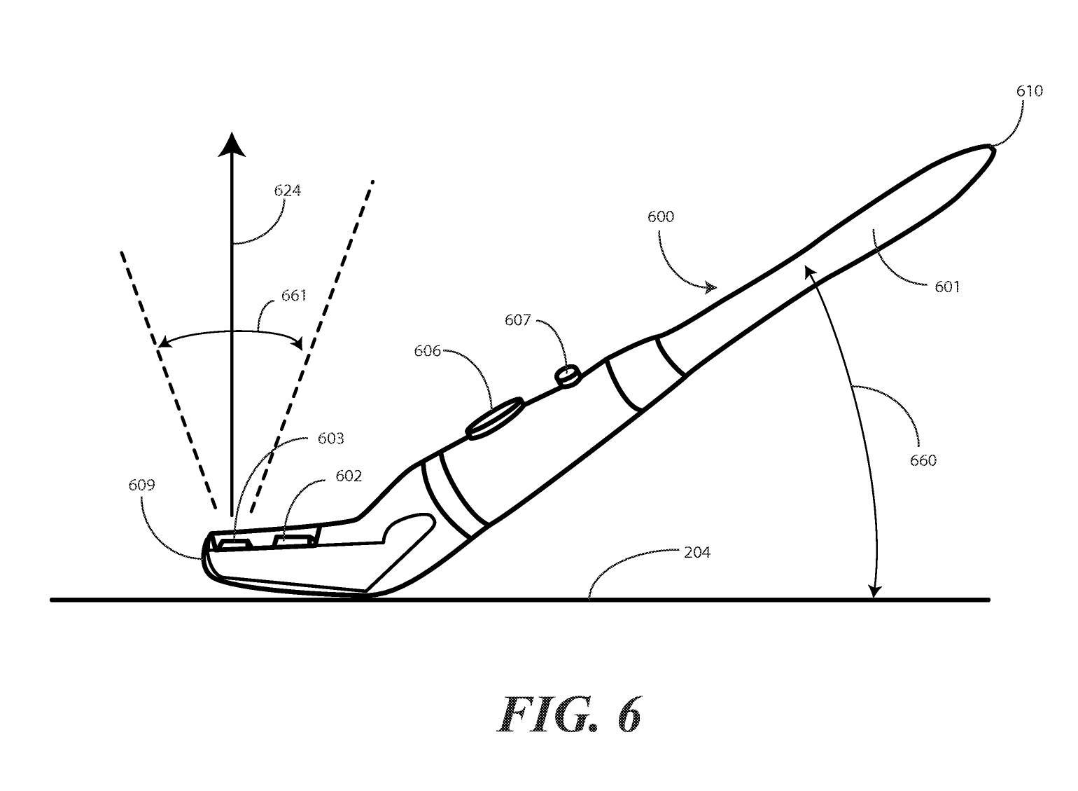

Turning now to FIG. 6, illustrated therein is an alternate embodiment of an input device 600 suitable for use with embodiments of the invention. In the embodiment of FIG. 6, the input device 600 is configured as a stylus positioned an angle 660 relative to the projection surface 204 such that the input device 600 can be easily and conveniently held in a user's hand. In one embodiment, the angle 660 is between 20 and 45 degrees, such as 30 degrees. The input device 600 has an elongated body 601 that is cylindrical in cross section and includes a first end 609 and a distally disposed second end 610.

As with the input device (300) of FIG. 3, the input device 600 of FIG. 6 includes a photodetector 602 and a phototransmitter 603. However, unlike the input device (300) of FIG. 3, the input device 600 of FIG. 6 has both the photodetector 603 and the phototransmitter 602 is disposed at the first end 609. This embodiment helps to ensure that the user's hand does not block the transmitted beam 624. In the illustrative embodiment of FIG. 6, the photodetector 603 is capable of receiving the projector's beam from angles of a wide range of angles 661.

As with the input device (300) of FIG. 3, the input device 600 of FIG. 6 can include user control mechanisms disposed along the side of the input device 600. The user control mechanisms allow the input device to function as a mouse or pointer and to control some of the functions of the image projection system (100). In the illustrative embodiment of FIG. 6, the user control mechanisms include a first select button 606 and a second select button 607. It will be clear to those of ordinary skill in the art having the benefit of this disclosure that these buttons are illustrative only, and that the user control mechanisms may have other functions or may have functionality that is user programmable. When the user manipulates one or more of these user control mechanisms, the control circuit is configured to encode user control data in the transmitted beam 624. The image projection system (100) then receives this user control data, decodes the data, and responds according to the control instructions therein.

In the foregoing specification, specific embodiments of the present invention have been described. However, one of ordinary skill in the art appreciates that various modifications and changes can be made without departing from the scope of the present invention as set forth in the claims below. Thus, while preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims.

What is claimed is:

1. An input device for use with an image projection system, comprising:
a photodetector configured to receive a scanned beam of photons from the image projection system, the scanned beam having a transmission characteristic associated therewith; and
a phototransmitter configured to deliver, in response to the photodetector receiving the scanned beam, a transmitted beam of photons to the image projection system that corresponds to the scanned beam received by the photodetector.

2. The input device of claim 1, further comprising a photoamplifier coupled between the photodetector and the phototransmitter, the photoamplifier being configured to amplify a magnitude of the scanned beam received by the photodetector.

3. The input device of claim 1, wherein the input device comprises an elongated cylinder having a first end and a second end, wherein the photodetector is disposed at the first end and the phototransmitter is disposed at the second end.

4. The input device of claim 3, further comprising a pressure detector and a control circuit coupled thereto, wherein the pressure detector is disposed at the first end, wherein the control circuit is configured, upon receiving the scanned beam and determining an applied pressure of the input device against a surface from the pressure detector, to encode the applied pressure in the transmitted beam.

5. The input device of claim 3, wherein the first end comprises a beam collector disposed at the first end such that photons collected by the beam collector are directed to the photodetector.

6. The input device of claim 5, wherein the photodetector comprises an avalanche photodiode, further wherein the phototransmitter comprises an infrared photodiode.

7. The input device of claim 1, wherein the transmitted beam corresponds to the scanned beam received by the photodetector by having the transmission characteristic.

8. The input device of claim 7, wherein the transmission characteristic comprises the scanned beam being within a predetermined transmission frequency range, wherein the predetermined transmission frequency range comprises one of a visible spectrum or an infrared spectrum.

9. The input device of claim 1, further comprising at least one user control mechanism and a control circuit coupled thereto, wherein the at least one user control mechanism is disposed along a side of the input device, wherein the control circuit is configured, in response to user manipulation of the at least one user control mechanism, to encode user control data in the transmitted beam.

10. The input device of claim 9, wherein the at least one user control mechanism comprises a button or a scroll wheel.

11. The input device of claim 1, further comprising at least one input device orientation detector and a control circuit coupled thereto, wherein the at least one input device orientation detector is configured to detect an orientation of the input device relative to an image projected by the image projection system, wherein the control circuit is configured, in response to the photodetector receiving the scanned beam and the at least one input device orientation detector determining the orientation, to encode input device orientation data in the transmitted beam.

12. The input device of claim 11, wherein the at least one input device orientation detector comprises one of a plurality of photodetectors or an accelerometer.

13. The input device of claim 1, wherein the input device further comprises a control circuit having a memory coupled thereto, wherein a unique input device identifier is stored within the memory, wherein the control circuit is configured, in response to the photodetector receiving the scanned beam, to encode the unique input device identifier in the transmitted beam.

14. The input device of claim 1, wherein the input device further comprises a control circuit, wherein the control circuit is configured to determine an input device latency defined by a delay occurring between the photodetector receiving the scanned beam and the phototransmitter delivering the transmitted beam, wherein the control circuit is configured, in response to both the photodetector receiving the scanned beam and the control circuit determining the input device latency, to encode the input device latency in the transmitted beam.

15. The input device of claim 1, wherein the transmitted beam comprises a serial code, the serial code comprising a beam received indicator and input device data, wherein the beam received indicator occurs before the input device data in the serial code.

16. A stylus for use with an image projection system capable of projecting images on a passive surface, the stylus comprising:
a photodetector configured to receive a beam of photons from the image projection system; and
at least one user control mechanism disposed along the stylus;
a control circuit coupled to the at least one user control mechanism; and
a phototransmitter coupled to the control circuit;
wherein the control circuit is configured, in response to one of the photodetector receiving the beam or the control circuit detecting a user manipulation of the at least one user control mechanism, to deliver an input signal from the phototransmitter to the image projection system, the input signal having user control data encoded therein.

17. The stylus of claim 16, further comprising a pressure detector coupled to the control circuit coupled, wherein the control circuit is further configured to encode applied pressure data in the input signal.

18. A projection system, comprising:
a laser-scanned beam display configured to generate an image on an image projection surface over a predefined region via a scanned beam of photons;
an input device in communication with the laser-scanned beam display, the input device comprising:
a photodetector configured to receive illumination of the scanned beam of photons from a selected location within the predefined region from the laser-scanned beam display; and
a phototransmitter configured to deliver, in response to the photodetector receiving the scanned beam, a transmitted beam of photons to the laser-scanned beam display; and
a display photodetector in the laser-scanned beam display configured to detect the transmitted beam.

19. The projection system of claim 18, wherein the laser-scanned beam display comprises a MEMS scanner.

20. The projection system of claim 18, wherein the laser-scanned beam display is configured to determine an X-Y location of the input device within the image upon receiving the transmitted beam.
